(19) United States
(12) Patent Application Publication
(10) Pub. No.: US 2007/0297204 A1
(43) Pub. Date: Dec. 27, 2007

(54) Power converter

(75) Inventors: Zeng-Yi Lu, Taoyuan Hsien (TW); Wei Chen, Taouan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/723,340

(22) Filed: Mar. 19, 2007

(30) Foreign Application Priority Data
Jun. 23, 2006 (TW) 095122721

(51) Int. Cl. H02M 7/537

(52) U.S. Cl. 363/131

(57) ABSTRACT

A power converter includes a power generating unit, at least two switching units, at least two transformers and a power outputting unit. The power generating unit generates a power signal. The switching units are electrically connected to the power generating unit, and the switching units respectively generate at least one switching signal according to the power signal. The transformers are electrically connected to the switching units, respectively. Each transformer has a first coil and a second coil. The first coils respectively receive the switching signals, and the second coils are electrically connected to each other in series. The power outputting unit is electrically connected to the first coils of the transformers.

### CROSS REFERENCE TO RELATED APPLICATIONS

This Non-provisional application claims priority under 35 U.S.C. §119(a) on Patent Application No(s). 095122721 filed in Taiwan, Republic of China on Jun. 23, 2006, the entire contents of which are hereby incorporated by reference.

### BACKGROUND OF THE INVENTION

1. Field of Invention

The invention relates to a power converter, and in particular, to a buck power converter.

2. Related Art

Referring to FIG. 1, a conventional multi-channel DC to DC converter 1 has multiple channels each composed of a set of switching elements 11 and an inductor 12, and transforms the DC power DC inputted to the switching elements 11 into the desired DC power DC, which is then outputted from an output terminal OUT, according to ON and OFF operations of the switching elements 11 and the energy storage function of the inductors 12.

Referring to FIG. 2, an additional conventional multi-channel DC to DC power converter 1′ has multiple channels each coupled using the switching elements 11 in conjunction with an anti-phase coupling transformer 13, transfers the DC power DC coupled to each channel to an output inductor 14 and an output capacitor 15, and outputs the DC power DC from the output terminal OUT.

As mentioned hereinabove, no direct coupling relationships exist between the channels in the conventional DC to DC power converter. When one of the channels experiences an abnormal current surge, the other channels cannot respond immediately and thus the dynamic response of the power converter is slowed. It is thus an important subject of the invention to provide a power converter with the enhanced dynamic response speed.

### SUMMARY OF THE INVENTION

In view of the foregoing, the invention is to provide a power converter capable of increasing a dynamic response speed.

To achieve the above, the invention discloses a power converter including a power generating unit, at least two switching units, at least two transformers and a power outputting unit. The power generating unit generates a power signal. The switching units are electrically connected to the power generating unit and both generate at least one switching signal according to the power signal. The transformers are electrically connected to the switching units, respectively. Each transformer has a first coil and a second coil. The first coils receive the switching signals, and the second coils are electrically connected to each other in series. The power outputting unit is electrically connected to the first coils of the transformers.

To achieve the above, the invention also discloses a power converter including a first power generating unit, a first switching unit, a second switching unit, at least one magnetic body and a power outputting unit. The power generating unit generates a power signal. The first switching unit is electrically connected to the power generating unit and generates at least one first switching signal according to the power signal. The second switching unit is electrically connected to the power generating unit and generates at least one second switching signal according to the power signal. The magnetic body has a central magnetic column, a first magnetic column, a second magnetic column, a central coil wound around the central magnetic column, a first coil wound around the first magnetic column, and a second coil wound around the second magnetic column. The first and second magnetic columns are respectively disposed on two sides of the central magnetic column. The first coil is electrically connected to the first switching unit and receives the first switching signal. The second coil is electrically connected to the second switching unit and receives the second switching signal. The power outputting unit is electrically connected to the first and second coils of the magnetic body. Herein, the central coil and the first coil construct a transformer, and the central coil and the second coil construct another transformer.

As mentioned above, the second coils of the transformers are electrically connected to each other in series in the power converter according to the invention so that the response speed of each channel can be increased through the coupling of the coils when one of the channels formed by the transformers experiences current surge. In addition, integrating at least two transformers into one magnetic body can reduce the size of the transformer in the actual circuit.

### BRIEF DESCRIPTION OF THE DRAWINGS

The invention will become more fully understood from the detailed description given herein below illustration only, and thus is not limitative of the present invention, and wherein:

FIGS. 1 and 2 are schematic illustrations showing conventional multi-channel DC to DC power converters;

FIG. 3 is a schematic illustration showing a power converter according to a first embodiment of the invention;

FIG. 4 is another schematic illustration showing the power converter according to the first embodiment of the invention;

FIG. 5 is a schematic illustration showing a transformer of the power converter of FIG. 3 implemented using an annular core;

FIG. 6 is a schematic illustration showing a power converter according to a second embodiment of the invention; and

FIG. 7 is a schematic illustration showing a power converter according to a third embodiment of the invention.

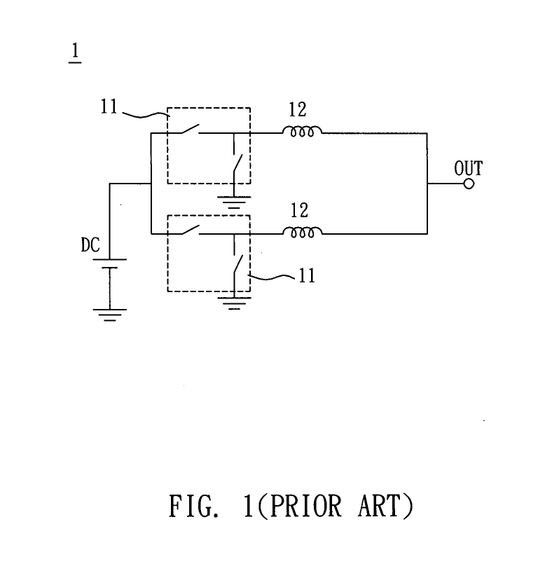

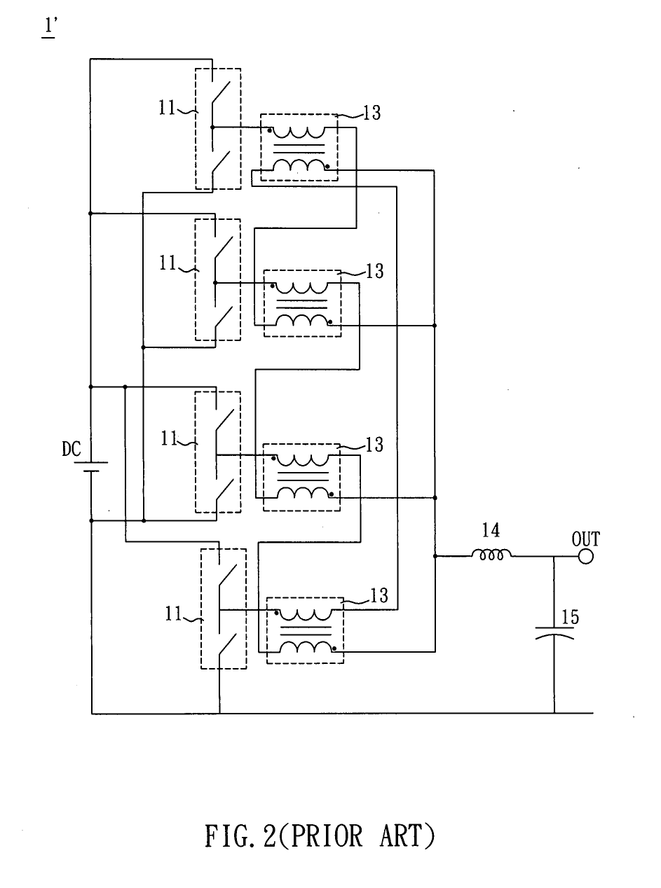

### DETAILED DESCRIPTION OF THE INVENTION

The present invention will be apparent from the following detailed description, which proceeds with reference to the accompanying drawings, wherein the same references relate to the same elements.

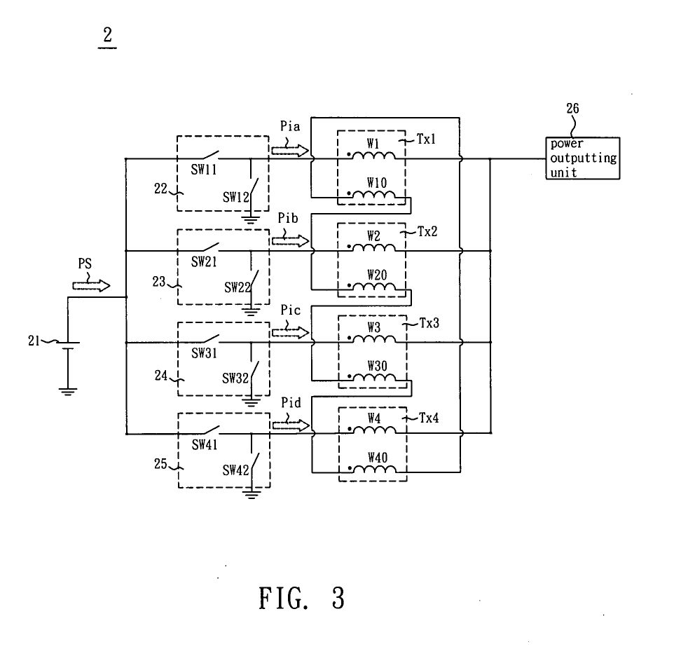

Referring to FIG. 3, a power converter 2 according to a first embodiment of the invention includes a power generating unit 21, at least two switching units, at least two transformers and a power outputting unit 26. In this embodiment, four switching units and four transformers are illustrated. In other words, the power converter 2 includes a first switching unit 22, a second switching unit 23, a third switching unit 24, a fourth switching unit 25, a first transformer Tx1, a second transformer Tx2, a third transformer Tx3 and a fourth transformer Tx4. In addition, the power converter is a DC to DC buck power converter (also referred to as a buck converter) in this embodiment.

The power generating unit 21 generates a power signal PS. In this embodiment, the power signal PS is a DC power signal.

The first switching unit 22, the second switching unit 23, the third switching unit 24 and the fourth switching unit 25 are respectively electrically connected to the power generating unit 21, and respectively generate a first switching signal Pia, a second switching signal Pib, a third switching signal Pic and a fourth switching signal Pid according to the power signal PS. According to the concept of the present invention, the phase difference between the switching signals is 360/n degrees, wherein n is the number of the switching units. In this embodiment, the phase differences between the first switching signal Pia, the second switching signal Pib, the third switching signal Pic and the fourth switching signal Pid are 360/4 degrees. That is, the phase differences between the switching signals are 90 degrees.

The first transformer Tx1, the second transformer Tx2, the third transformer Tx3 and the fourth transformer Tx4 are electrically connected to the first switching unit 22, the second switching unit 23, the third switching unit 24 and the fourth switching unit 25, respectively. Each transformer has a first coil and a second coil. That is, the first transformer Tx1 has a first coil W1 and a second coil W10, the second transformer Tx2 has a first coil W2 and a second coil W20, the third transformer Tx3 has a first coil W3 and a second coil W30, and the fourth transformer Tx4 has a first coil W4 and a second coil W40. In addition, the first coils W1, W2, W3 and W4 respectively receive the first switching signal Pia, the second switching signal Pib, the third switching signal Pic and the fourth switching signal Pid, and the second coils W10, W20, W30 and W40 are electrically connected to each other in series to form a loop.

As shown in FIG. 3, the first switching unit 22 has a first switching element SW11 and a second switching element SW12, the second switching unit 23 has a first switching element SW21 and a second switching element SW22, the third switching unit 24 has a first switching element SW31 and a second switching element SW32, and the fourth switching unit 25 has a first switching element SW41 and a second switching element SW42. Each of the first switching elements SW11, SW21, SW31 and SW41 and each of the second switching elements SW12, SW22, SW32 and SW42 are respectively electrically connected to each of the first coils W1, W2, W3 and W4 in parallel. The first switching elements SW11, SW21, SW31 and SW41 and the second switching elements SW12, SW22, SW32 and SW42 may be either bipolar transistors (BJTs) or field effect transistors (FETs).

The power outputting unit 26 is electrically connected to the first coils W1, W2, W3 and W4 of the first, second, third and fourth transformers Tx1, Tx2, Tx3, Tx4 respectively, in order to output the power signal transformed by each of the transformers.

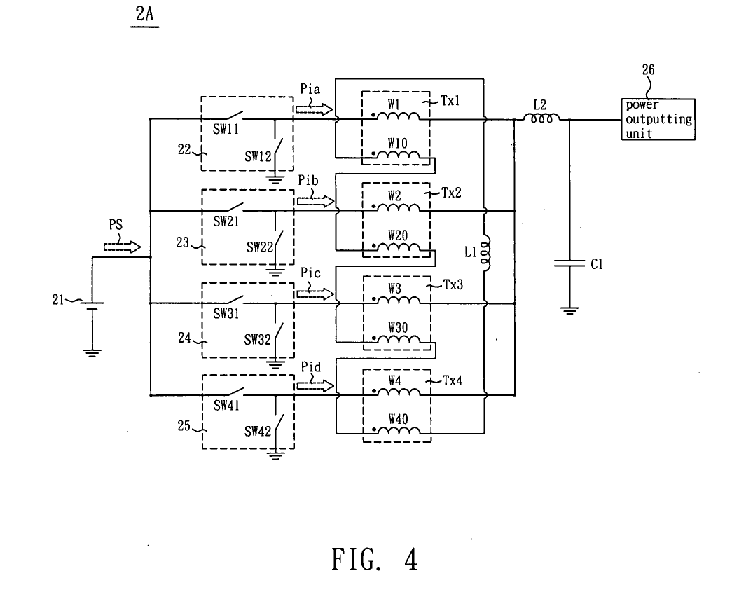

Referring to FIG. 4, the power converter 2A of this embodiment further includes a first inductor L1, a second inductor L2 and a capacitor C1 in comparison with the power converter 2 shown in FIG. 3. The first inductor L1 is electrically connected to the second coils W10, W20, W30 and W40 of the first, second, third and fourth transformers Tx1, Tx2, Tx3, Tx4, respectively, and the first inductor L1 is electrically connected to and between the second coil W10 of the first transformer Tx1 and the second coil W40 of the fourth transformer Tx4 in series. The second inductor L2 has a first terminal electrically connected to the power outputting unit 26 and a second terminal electrically connected to the first coils W1, W2, W3 and W4 of the first, second, third and fourth transformers Tx1, Tx2, Tx3, Tx4, respectively, wherein the second terminal of the second inductor L2 is electrically connected to the first coils W1, W2, W3 and W4 of the first, second, third and fourth transformers Tx1, Tx2, Tx3, Tx4, respectively, in parallel. The capacitor C1 is electrically connected to the power outputting unit 26. In the embodiment shown in FIG. 4, the first inductor L1 can be a linear inductor or a non-linear inductor. In addition, the power converter 2A may include either one or both of the first inductor L1 and the second inductor L2.

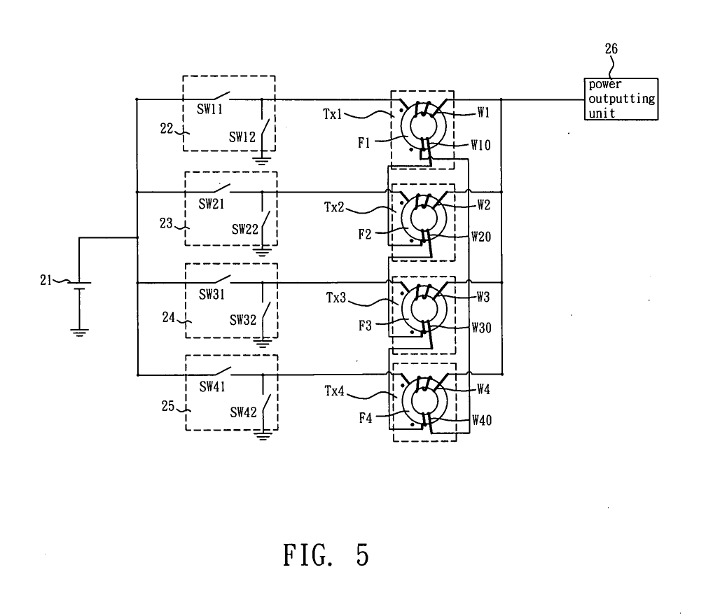

Again taking the power converter 2 of FIG. 3 as an example, each of the transformers thereof has the actual structure shown in FIG. 5. Each of the transformers Tx1, Tx2, Tx3 and Tx4 can be formed by winding the first coils W1, W2, W3 and W4 and the second coils W10, W20, W30 and W40 around annular cores F1, F2, F3 and F4, respectively, and the second coils W10, W20, W30 and W40 are connected in series to form a loop. The above-mentioned embodiment takes four channels as an example, and other modified aspects may also be connected according to this rule. So, detailed descriptions of the possible modified aspects will be omitted.

To be noted, the embodiments shown in FIGS. 3 and 5 utilize the static inductance and dynamic inductance to achieve the desired effects. Accordingly, the coupling coefficients of the first, second, third and fourth transformers Tx1, Tx2, Tx3, Tx4, which are also the coupling coefficients between the first coils W1, W2, W3 and W4 and the second coils W10, W20, W30 and W40, respectively, should be considered carefully. When the coupling coefficient approaches 1, the static and dynamic inductances may decrease to 0, which is undesired in these embodiments. In these embodiments shown in FIGS. 3 and 5, the coupling coefficients of the transformers Tx1, Tx2, Tx3 and Tx4 are less than 0.95.

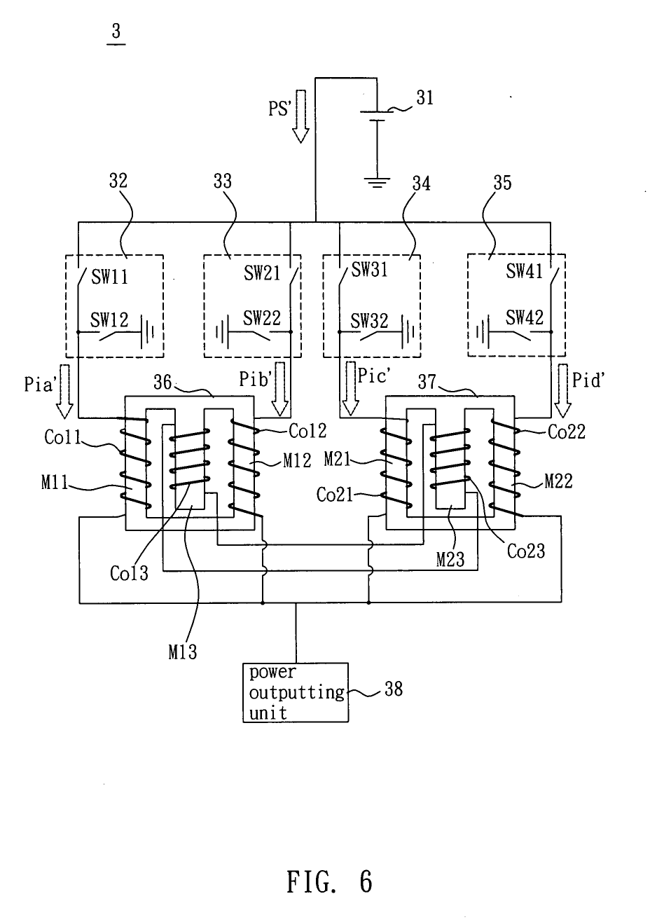

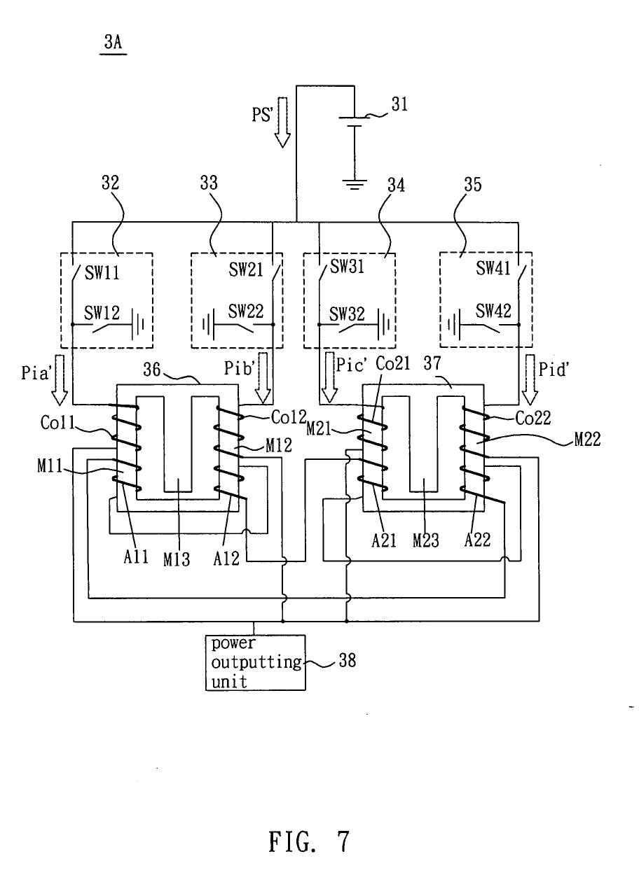

As shown in FIGS. 6 and 7, a power converter 3 according to a second embodiment of the invention will be described. In this embodiment, descriptions are mainly made with reference to the structure of the transformer.

Referring to FIG. 6, the power converter 3 according to the second embodiment of the invention includes a power generating unit 31, a first switching unit 32, a second switching unit 33, a third switching unit 34, a fourth switching unit 35, a first magnetic body 36, a second magnetic body 37 and a power outputting unit 38. The structures and the functions of the power generating unit 31, the first, second, third and fourth switching units 32, 33, 34, 35 and the power outputting unit 38 are the same as those of the power generating unit 21, the first, second, third and fourth switching units 22, 23, 24, 25 and the power outputting unit 26 according to the first embodiment shown in FIG. 5. That is, the power generating unit 31 generates a power signal PS′. The first, second, third and fourth switching units 32, 33, 34, 35 respectively generate a first switching signal Pia′, a second switching signal Pib′, a third switching signal Pic′ and a fourth switching signal Pid′. The connections for the inductor or the capacitor are the same as those for the first embodiment, so detailed descriptions thereof will be omitted.

The first magnetic body 36 has a first magnetic column M11, a second magnetic column M12, a central magnetic column M13, a first coil Co11, a second coil Co12 and a central coil Co13, and the first and second magnetic columns M11, M12 are respectively disposed on two sides of the central magnetic column M13. The central coil Co13 is wound around the central magnetic column M13. The first coil Co11 is wound around the first magnetic column M11. The second coil Co12 is wound around the second magnetic column M12. In this embodiment, the first coil Co11 is electrically connected to the first switching unit 32 and receives the first switching signal Pia′, and the second coil Co12 is electrically connected to the second switching unit 33 and receives the second switching signal Pib′.

The second magnetic body 37 has a first magnetic column M21, a second magnetic column M22, a central magnetic column M23, a first coil Co21, a second coil Co22 and a central coil Co23, and the first and second magnetic columns M21, M22 are respectively disposed on two sides of the central magnetic column M23. The central coil Co23 is wound around the central magnetic column M23. The first coil Co21 is wound around the first magnetic column M21. The second coil Co22 is wound around the second magnetic column M22. In this embodiment, the first coil Co21 is electrically connected to the third switching unit 34 and receives the third switching signal Pic′, and the second coil Co22 is electrically connected to the fourth switching unit 35 and receives the fourth switching signal Pid′. In addition, the central coil Co13 of the first magnetic body 36 and the central coil Co23 of the second magnetic body 37 are electrically connected to each other in series to form a loop in this embodiment.

As mentioned hereinabove, the construction of the central coil Co13 and the first coil Co11 of the first magnetic body 36 is similar to the first transformer Tx1 of the first embodiment; the construction of the central coil Co13 and the second coil Co12 of the first magnetic body 36 is similar to the second transformer Tx2 of the first embodiment; the construction of the central coil Co23 and the first coil Co21 of the second magnetic body 37 is similar to the third transformer Tx3 of the first embodiment; and the construction of the central coil Co23 and the second coil Co22 of the second magnetic body 37 is similar to the fourth transformer Tx4 of the first embodiment. The central coils Co13 and Co23 correspond to the second coil of each transformer in the first embodiment.

As shown in FIG. 7, the elements and the connections of the power converter 3A according to the third embodiment of the invention are similar to those of the power converter 3 of the second embodiment except that the first magnetic body 36 has a first magnetic column M11, a second magnetic column M12, a central magnetic column M13, a first coil Co11, a second coil Co12, a first additional coil A11, and a second additional coil A12, and the first and second magnetic columns M11, M12 are disposed on two sides of the central magnetic column M13, respectively. The first coil Co11 and the first additional coil A11 are wound around the first magnetic column M11, and the second coil Co12 and the second additional coil A12 are wound around the second magnetic column M12. In this embodiment, the first coil Co11 is electrically connected to the first switching unit 32 and receives the first switching signal Pia′, and the second coil Co12 is electrically connected to the second switching unit 33 and receives the second switching signal Pib′. The second magnetic body 37 has a first magnetic column M21, a second magnetic column M22, a central magnetic column M23, a first coil Co21, a second coil Co22, a first additional coil A21 and a second additional coil A22, and the first and second magnetic columns M21, M22 are disposed on two sides of the central magnetic column M23, respectively. The first coil Co21 and the first additional coil A21 are wound around the first magnetic column M21, and the second coil Co22 and the second additional coil A22 are wound around the second magnetic column M22. In this embodiment, the first coil Co21 is electrically connected to the third switching unit 34 and receives the third switching signal Pic′, and the second coil Co22 is electrically connected to the fourth switching unit 35 and receives the fourth switching signal Pid′. In addition, the first and second additional coils A11, A12 of the first magnetic body 36 and the first and second additional coils A21, A22 of the second magnetic body 37 are electrically connected together in series to form a loop in this embodiment.

As mentioned hereinabove, the construction of the first additional coil A11 and the first coil Co11 of the first magnetic body 36 is similar to the first transformer Tx1 of the first embodiment; the construction of the second additional coil A12 and the second coil Co12 of the first magnetic body 36 is similar to the second transformer Tx2 of the first embodiment; the construction of the first additional coil A21 and the first coil Co21 of the second magnetic body 37 is similar to the third transformer Tx3 of the first embodiment; and the construction of the second additional coil A22 and the second coil Co22 of the second magnetic body 37 is similar to the fourth transformer Tx4 of the first embodiment.

In summary, the second coils of the transformers are electrically connected to each other in series in the power converter according to the invention so that the response speed of each channel can be increased through the coupling of the coils when one of the channels formed by the transformers experiences current surge. In addition, integrating at least two transformers into one magnetic body can reduce the size of the transformer in the actual circuit.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A power converter comprising:
a power generating unit for generating a power signal;
at least two switching units electrically connected to the power generating unit for generating at least one switching signal according to the power signal, respectively;
at least two transformers electrically connected to the switching units, respectively, wherein each of the transformers has a first coil receiving the switching signals, and a second coil electrically connected to each other in series; and
a power outputting unit electrically connected to the first coils of the transformers.

2. The power converter according to claim 1, wherein the power converter is a DC to DC buck power converter, and the switching units are bipolar transistors or field effect transistors.

3. The power converter according to claim 1, wherein a phase difference between the switching signals is 360/n degrees, wherein n is the number of the switching units.

4. The power converter according to claim 1, further comprising a first inductor electrically connected to the second coils of the transformers.

5. The power converter according to claim 4, wherein the first inductor is a linear inductor or a non-linear inductor.

6. The power converter according to claim 4, wherein the first inductor is electrically connected to and between the second coils of the transformers in series.

7. The power converter according to claim 1, further comprising a second inductor electrically connected to the power outputting unit and the first coils of the transformers.

8. The power converter according to claim 1, further comprising a capacitor electrically connected to the power outputting unit.

9. The power converter according to claim 1, wherein the second coils are electrically connected together in series to form a loop.

10. The power converter according to claim 1, wherein coupling coefficients of the transformers are less than 0.95.

11. A power converter comprising:
a power generating unit for generating a power signal;
a first switching unit electrically connected to the power generating unit for generating at least one first switching signal according to the power signal;
a second switching unit electrically connected to the power generating unit for generating at least one second switching signal according to the power signal;
at least one magnetic body having a central magnetic column, a first magnetic column, a second magnetic column, a central coil wound around the central magnetic column, a first coil wound around the first magnetic column, and a second coil wound around the second magnetic column, wherein the first magnetic column and the second magnetic column are respectively disposed on two sides of the central magnetic column, the first coil is electrically connected to the first switching unit for receiving the first switching signal, and the second coil is electrically connected to the second switching unit for receiving the second switching signal; and
a power outputting unit respectively electrically connected to the first coil and the second coil of the magnetic body.

12. The power converter according to claim 11, wherein the power converter is a DC to DC buck power converter, and the switching units are bipolar transistors or field effect transistors.

13. The power converter according to claim 11, wherein a phase difference between the switching signals is 360/n degrees, wherein n is the number of transformers provided by the magnetic bodies.

14. The power converter according to claim 11, further comprising a first inductor electrically connected to the central coil of the magnetic body in series.

15. The power converter according to claim 11, further comprising a second inductor electrically connected to the power outputting unit, the first coil and the second coil.

16. The power converter according to claim 11, further comprising a capacitor electrically connected to the power outputting unit.

17. The power converter according to claim 11, wherein the central coils are electrically connected together in series to form a loop.

18. The power converter according to claim 11, wherein each of the first switching unit and the second switching unit has a first switching element and a second switching element, and the first switching elements and the second switching elements are electrically connected to the first coil and the second coil in parallel, respectively.

19. A power converter comprising:
a power generating unit for generating a power signal;
a first switching unit, which is electrically connected to the power generating unit and generates at least one first switching signal according to the power signal;
a second switching unit, which is electrically connected to the power generating unit and generates at least one second switching signal according to the power signal;
at least one magnetic body having a central magnetic column, a first magnetic column, a second magnetic column, a first coil wound around the first magnetic column, a first additional coil wound around the first magnetic column, a second coil wound around the second magnetic column and a second additional coil wound around the second magnetic column, wherein the first additional coil and the second additional coil are electrically connected together in series, the first coil is electrically connected to the first switching unit for receiving the first switching signal, and the second coil is electrically connected to the second switching unit for receiving the second switching signal; and
a power outputting unit electrically connected to the first coil and the second coil of the magnetic body.

20. The power converter according to claim 19, further comprising a first inductor electrically connected to the first additional coil of the magnetic body in series.
